(19) United States
(12) Patent Application Publication
(10) Pub. No.: US 2024/0300662 A1
(43) Pub. Date: Sep. 12, 2024

(54) POWER MANAGEMENT SYSTEM AND CONTROLS FOR HYBRID ELECTRIC AIRCRAFT

(71) Applicant: General Electric Company, Schenectady, NY (US)

(72) Inventors: Vinod Kumar, Cincinnati, OH (US); Kevin Richard Graziano, Cincinnati, OH (US)

(21) Appl. No.: 18/180,381

(22) Filed: Mar. 8, 2023

(51) Int. Cl. B64D 31/14; B64D 27/10; B64D 27/24; B64D 31/08; B64D 35/02

(52) U.S. Cl. CPC B64D 31/18; B64D 35/025; H02P 9/008; B64C 13/16

(57) ABSTRACT

A hybrid gas turbine engine for use on an aircraft includes a motor/generator and gas turbine engine placed in parallel power communication with a rotating bladed component, such as an aircraft propeller, through a combining gear box. Power can be modulated with the propeller using the motor/generator. An aircraft having the aircraft propeller can also include several aircraft systems such as an air data computer, automatic flight control system (AFCS), a guidance and navigation system, a full authority digital engine controller/flight control computer (FADEC/FCC), and a fault detection and mitigation controller (FDMC). Data from each of these respective systems can be communicated over an aircraft data bus. In one form data from the AFCS and guidance and navigation system can be provided over the aircraft bus to the FDMC to modulate power to the propeller and in some forms act as a backup to the FADEC/FCC.

### FIELD

The present disclosure relates generally to hybrid electric gas turbine engines for use on an aircraft.

### BACKGROUND

A hybrid electric gas turbine engine combination can be used to provide mechanical power to a rotating bladed component such as a propeller useful to provide propulsive force to an aircraft. An electric motor/generator and a gas turbine engine can be placed in parallel mechanical communication with the rotating bladed component through use of, for example, a combining gear box. The aircraft can include several systems, including a guidance and navigation system along with an air data system. Making full use of aircraft systems with the hybrid electric gas turbine engine arrangement remains an area of interest.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 is a cross-sectional view of a gas turbine engine in accordance with an exemplary aspect of the present disclosure.

FIG. 2 is a schematic view of two hybrid electric gas turbine engines in accordance with the present disclosure.

FIG. 3 is a schematic view of an aircraft control system for use with a hybrid electric gas turbine engine in accordance with the present disclosure.

FIG. 4 is a view of various lever settings of operating a hybrid electric gas turbine engine in accordance with the present disclosure.

FIG. 5 is a schematic view of an aircraft control system for use with a hybrid electric gas turbine engine in accordance with the present disclosure.

FIG. 6 is a schematic view of an aircraft control system for use with a hybrid electric gas turbine engine in accordance with the present disclosure

FIG. 7 is a schematic view of an aircraft control system for use with a hybrid electric gas turbine engine in accordance with the present disclosure

FIG. 8 is a view of a controller in accordance with the present disclosure

FIG. 9 is a flow chart describing a method of operating a hybrid electric gas turbine engine configured to provide propulsive power to an aircraft having a bladed rotating component in accordance with the present disclosure.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The singular forms “a”, “an”, and “the” include plural references unless the context clearly dictates otherwise.

The term “at least one of” in the context of, e.g., “at least one of A, B, and C” refers to only A, only B, only C, or any combination of A, B, and C.

The term “gas turbine engine” refers to an engine having a turbomachine as all or a portion of its power source.

The term “combustion section” refers to any heat addition system for a turbomachine. For example, the term combustion section may refer to a section including one or more of a deflagrative combustion assembly, a rotating detonation combustion assembly, a pulse detonation combustion assembly, or other appropriate heat addition assembly. In certain example embodiments, the combustion section may include an annular combustor, a can combustor, a cannular combustor, a trapped vortex combustor (TVC), or other appropriate combustion system, or combinations thereof.

The terms “low” and “high”, or their respective comparative degrees (e.g., -er, where applicable), when used with a compressor, a turbine, a shaft, or spool components, etc. each refer to relative pressure within an engine unless otherwise specified. For example, a “low turbine” or “low pressure turbine” defines a component configured to operate at a pressure lower than a “high pressure turbine” of the engine.

The terms “forward” and “aft” refer to relative positions within a gas turbine engine or vehicle, and refer to the normal operational attitude of the gas turbine engine or vehicle. For example, with regard to a gas turbine engine, forward refers to a position closer to an engine inlet and aft refers to a position closer to an engine nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows.

As used herein, the terms “axial” and “axially” refer to directions and orientations that extend substantially parallel to a centerline of the gas turbine engine. Moreover, the terms “radial” and “radially” refer to directions and orientations that extend substantially perpendicular to the centerline of the gas turbine engine. In addition, as used herein, the terms “circumferential” and “circumferentially” refer to directions and orientations that extend arcuately about the centerline of the gas turbine engine.

As will be discussed in more detail below, the subject matter of the present disclosure is directed generally to operating hybrid electric gas turbine engines in which a gas turbine engine and an electric motor/generator are in power communication with rotating bladed component used to provide propulsive power to an aircraft. The aircraft can include an aircraft control system which includes several different systems used to monitor aircraft information, receive pilot commands, such as a guidance command, and provide an integrated set of commands to aircraft control surfaces and power management of the hybrid electric gas turbine engine. In one form the aircraft control system can use an electric machine controller to modulate the motor-generator based on data received from a flight controller on the aircraft. Such use of the electric machine controller to receive flight related information provides flexibility for a variety of aircraft configurations and redundancy to existing systems.

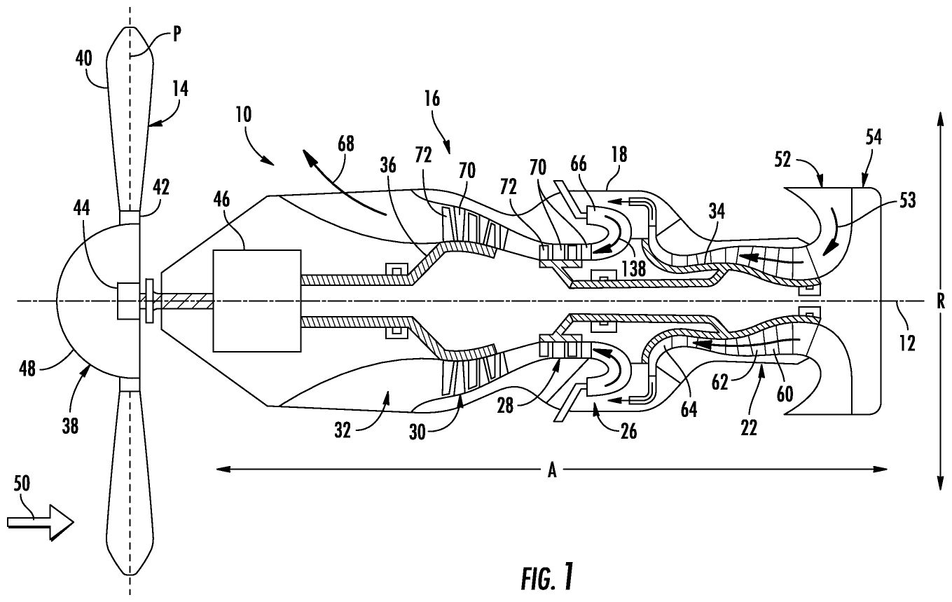

Referring now to the drawings, wherein identical numerals indicate the same elements throughout the figures, FIG. 1 is a schematic cross-sectional view of a gas turbine engine in accordance with an exemplary embodiment of the present disclosure. More particularly, for the embodiment of FIG. 1, the gas turbine engine is a flow turboprop engine 10, referred to herein as “turboprop engine 10.” It is contemplated that various embodiments of the instant application can be configured as other types of gas turbine engines, including turbofan engines.

As shown in FIG. 1, turboprop engine 10 defines an axial direction A (extending parallel to a longitudinal centerline or central axis 12 provided for reference), a radial direction R, and a circumferential direction C (not shown) disposed about the axial direction A. Turboprop engine 10 generally includes a propeller section 14 and a core turbine engine 16 disposed downstream from the propeller section 14, the propeller section 14 being operable with, and driven by, core turbine engine 16.

The exemplary core turbine engine 16 depicted generally includes a substantially tubular outer casing 18 extending generally along axial direction A. Outer casing 18 generally encloses core turbine engine 16 and may be formed from a single casing or multiple casings. Core turbine engine 16 includes, in a serial flow relationship, a compressor 22, a combustion section 26, a high pressure (HP) turbine 28, a low pressure (LP) turbine 30, and an exhaust section 32. An air flow path generally extends through compressor 22, combustion section 26, HP turbine 28, LP turbine 30, and exhaust section 32 which are in fluid communication with each other.

An HP shaft or spool 34 drivingly connects the HP turbine 28 to the compressor 22. A LP shaft or spool 36 drivingly connects the LP turbine 30 to propeller section 14 of the turboprop engine 10. For the embodiment depicted, propeller section 14 includes a variable pitch propeller 38 having a plurality of propeller blades 40 coupled to a disk 42 in a spaced apart manner. As depicted, the propeller blades 40 extend outwardly from disk 42 generally along the radial direction R. Each propeller blade 40 is rotatable relative to the disk 42 about a pitch axis P by virtue of the propeller blades 40 being operatively coupled to a suitable actuation member 44 configured to collectively vary the pitch of the propeller blades 40 in unison. The propeller blades 40, disk 42, and actuation member 44 are together rotatable about the longitudinal axis 12 by LP shaft 36 across a power gear box 46. The power gear box 46 includes a plurality of gears for stepping down the rotational speed of the LP shaft 36 to a more efficient rotational fan speed and is attached to one or both of a core frame or a fan frame through one or more coupling systems. Disk 42 is covered by a rotatable front hub 48 aerodynamically contoured to promote an airflow through the plurality of propeller blades 40.

During operation of the turboprop engine 10, a volume of air 50 passes through blades 40 of propeller 38 and is urged toward a radial inlet 52 of core turbine engine 16. More specifically, turboprop engine 10 includes an intake channel 54 that defines radial inlet 52 that routes an inlet portion 53 of the flow of air 50 from inlet 52 downstream to compressor 22. Though the inlet 52 is depicted as a radial inlet in the embodiment of FIG. 1, other configurations of inlet 52 are also contemplated. For example, the inlet 52 can also take the form of an inlet arranged in an axial direction to capture the inlet portion 53 of the volume of air 50. The inlet portion 53 of the flow of air 50 captured by the inlet 52 is referred to herein as an intake flow of air. The intake channel 54 defines the intake flow of air and generally extends from an inlet of the intake channel 54 to just upstream of the compressor 22.

The turboprop engine 10 embodiments described herein can, but need not, be configured as reverse flow engines. Such engines are characterized by a general relationship between the direction of the flow of incoming air 50 (such direction can be used to characterize the relative motion of air during a mode of operation of the turboprop engine 10 such as a forward thrust mode) and that of the flow of air axially through the turboprop engine 10. The flow of air through the core turbine engine 16 is generally reverse to that of the flow of incoming air 50. Turning the flow from the direction of the incoming flow of air 50 to the axial direction through the core turbine engine 16 is usually performed by the intake channel 54. The change of direction is substantially reversed in that the bulk direction of the flow of air 50 (itself having a circumferential swirl component imparted by the propeller blades 40 in addition to a longitudinal component) is substantially opposite, or reverse, to the bulk direction of air flow axially through the core turbine engine 16 (which itself also includes a longitudinal component but also include radial and circumferential components owing to the shape of the flow path and swirl induced by rotating turbomachinery components) during one or more phases of operation of the core turbine engine 16. Thus, it will also be appreciated that the term “reverse” is a relative comparison of the longitudinal components of the bulk flow of air 50 and bulk flow of air axially within the engine 10. Though the longitudinal direction of the flow of air 50 may not be perfectly parallel with the axial flow of air through the engine 10, those of skill in the art will nevertheless appreciate that the longitudinal components of the directions the flow of air 50 and the axial flow are substantially reversed.

Compressor 22 includes one or more sequential stages of compressor stator vanes 60, one or more sequential stages of compressor rotor blades 62, and an impeller 64. Though the illustrated embodiment includes both axial and centrifugal flow compressors, in some forms the turboprop engine 10 can include just an axial flow compressor(s) or centrifugal flow compressor(s). The one or more sequential stages of compressor stator vanes 60 are coupled to the outer casing 18 and compressor rotor blades 62 are coupled to HP shaft 34 to progressively compress the inlet portion 53 of the volume of air 50 (or simply “air 53”). Impeller 64 further compresses air 53 and directs the compressed air 53 into combustion section 26 where air 53 mixes with fuel. Combustion section 26 includes a combustor 66 which combusts the air/fuel mixture to provide combustion gases 68.

Combustion gases 68 flow through HP turbine 28 which includes one or more sequential stages of turbine stator vanes 70 and one or more sequential stages of turbine blades 72. The one or more sequential stages of turbine stator vanes 70 are coupled to the outer casing 18 and turbine blades 72 are coupled to HP shaft 34 extract thermal and/or kinetic energy therefrom. Combustion gases 68 subsequently flow through LP turbine 30, where an additional amount of energy is extracted through additional stages of turbine stator vanes 70 and turbine blades 72 coupled to LP shaft 36. The energy extraction from HP turbine 28 supports operation of compressor 22 through HP shaft 34 and the energy extraction from LP turbine 30 supports operation of propeller section 14 through LP shaft 36. Combustion gases 68 exit turboprop engine 10 through exhaust section 32.

It will be understood that one or more rows of stator vanes 60 and 70 can, in some embodiments, be variable vanes controlled by Furthermore, with particular respect to stator vanes 70, one or more rows of the stator vanes 70, whether in either or both of the LP turbine 30 and HP turbine 28, can be variable.

In other exemplary embodiments, the turbine engine may include any suitable number of compressors, turbines, shafts, etc. For example, as will be appreciated, HP shaft 34 and LP shaft 36 may further be coupled to any suitable device for any suitable purpose. For example, in certain exemplary embodiments, turboprop engine 10 of FIG. 1 may be utilized in aeroderivative applications, or may be attached to a propeller for an airplane. Additionally, in other exemplary embodiments, turboprop engine 10 may include any other suitable type of combustor, and may not include the exemplary reverse flow combustor depicted.

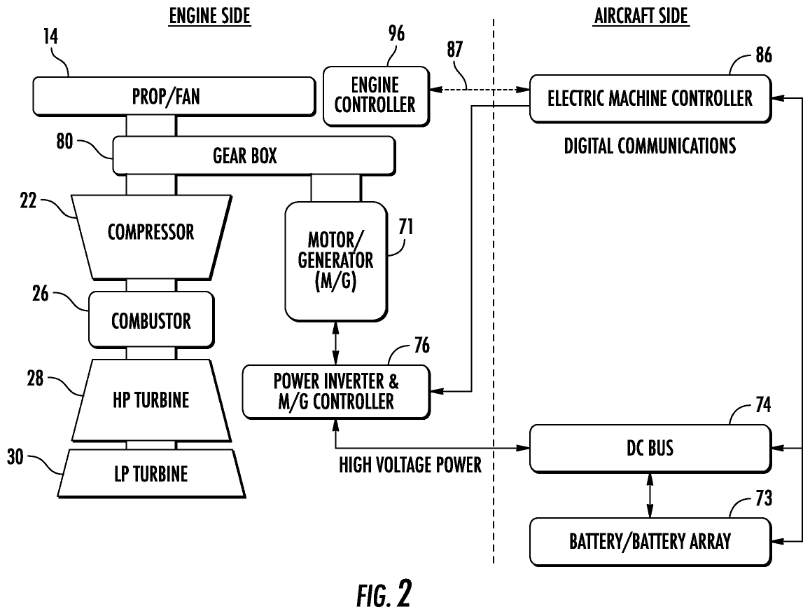

Referring now to FIG. 2, a schematic view of gas turbine engine 10 in accordance with another exemplary aspect of the present disclosure is provided in which the engine 10 is part of a hybrid aircraft power plant system. The exemplary gas turbine engine 10 of FIG. 2 may be configured in substantially the same manner as the exemplary turboprop engine 10 of FIG. 1, and accordingly, the same or similar numbers may refer to the same or similar parts.

FIG. 2 depicts a configuration of the gas turbine engine 10 that is in mechanical power communication with an electric machine (e.g., a motor/generator (MG) 71) and LP shafts of the engine 10. The hybrid aircraft power plant system depicted in FIG. 2 is arranged in a so-called parallel configuration such that the MG 71 can provide power to the LP shaft (and consequently the propellers 14) along with and in parallel to the gas turbine engine 10. As will be appreciated, in some modes of operation, the motor-generator can extract power from the LP shaft to provide power to the an energy storage device, such as a battery (in which case it operates in generator mode), while in other modes of operation, the motor-generator can provide power to the LP shaft (in which case it operates in motor mode). Although only a single gas turbine engine 10 and MG 71 is depicted, in other embodiments additional gas turbine engines 10 and/or MGs 71 can be used. A variety of control schemes are possible in the context of multiple gas turbine engines 10 having associated MGs 71. For example, energy extracted from an LP shaft 36 by an associated MG 71 can be transferred to the energy storage device 73 which can, in turn, provide power to another MG 71 associated with another gas turbine engine 10 to drive a propeller 14 on the other gas turbine engine 10.

Several additional systems enable the mechanical power communication between the MG 71 and gas turbine engine. In particular, the MG 71 can be driven by an energy storage 73, such as battery or bank of batteries, coupled to direct current (DC) bus 74. The energy storage 73 can be charged by the turboprop engine 10 when operating the MG 71 in generator mode. Voltage provided over the DC bus 74 can be delivered to a power inverter and motor-generator controller 76 (MG controller 76) to provide AC power to the MG 71. The MG 71 is coupled through shafts 78 to gearbox 80, although, in other embodiments, the MG 71 can be integrated into the shaft. The gearbox 80 is also coupled to the gas turbine engine 10 through the LP shaft 36. The gearbox 80 can be configured in any suitable type of gearing arrangement to sum power between the shaft 78 (associated with the motor-generator 71) and 36 (associated with the gas turbine 10. In some forms, the gearbox 80 can include any suitable clutch mechanism to account for power mismatches between shafts 78 and 36. The gearbox 80 can be used to receive input shaft 78/36 from the gas turbine engine 10 and provide an output power to the propeller 14. Any variety of power flows are contemplated herein.

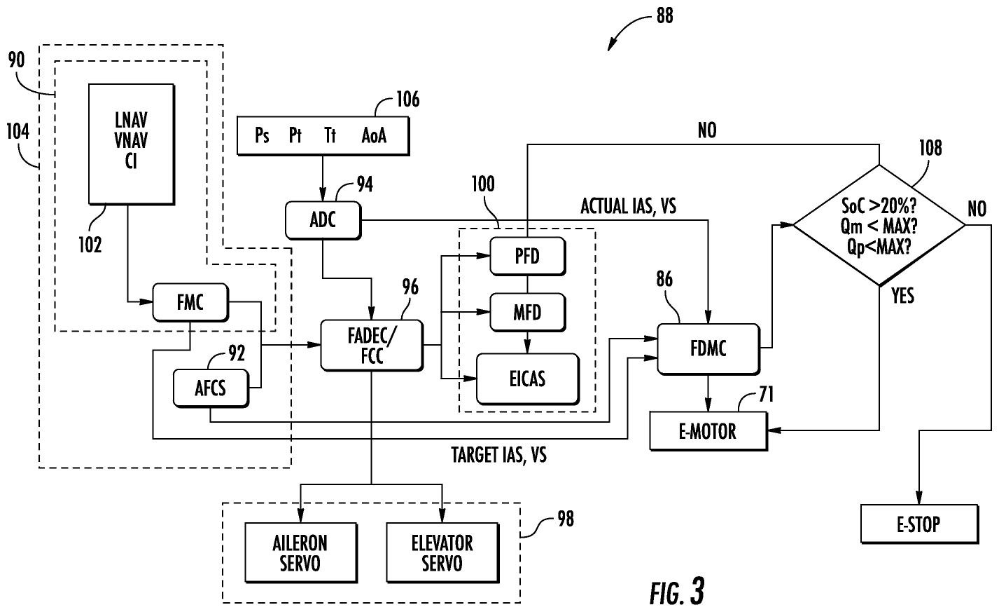

Electrical power management and monitoring of an electrical power plant system, which includes one or more of respective systems of the energy storage 73, DC bus 74, MG controller 76, and MG 71, can be performed by an electric machine controller 86 (highlighted in FIGS. 3, 5, 6, and 7). The electric machine controller 86 is capable of monitoring performance of the electrical power plant system through a variety of sensors associated with any of the respective systems and power interconnections, and mitigating faults which occur. For example, the electric machine controller 86 can be configured to monitor the MG controller 76, detect a fault within the MG controller 76, and take an action to mitigate the fault.

In some embodiments, the electric machine controller 86 can be used to provide hybrid control for the hybrid gas turbine engine 10 and MG 71. The dashed line 87 depicted in FIG. 2 indicates the electric machine controller 86 can be in one or two way communication with the engine controller 96, where the electric machine controller 86 can be configured as a hybrid controller capable of monitoring and/or receiving various signals related to the performance of the hybrid aircraft powerplant system which includes the MG 71 and gas turbine engine 10 used to drive the propeller 14. As such, the electric machine controller 86 can be referred to herein as a hybrid electric machine controller. Various embodiments depicted in the following figures will be understood as in some forms having the electric machine controller 86 in the form of the hybrid electric machine controller. As will be discussed further below, the electric machine controller 86 can monitor a torque level of the MG 71, a state of charge of the energy storage 73, and receive data from other systems on the aircraft such as receiving propeller torque from an engine controller to determine if operating of the MG 71 in the motor mode should continue.

Turning now to FIG. 3, an exemplary embodiment of an aircraft control system 88 which can be used in conjunction with the hybrid aircraft power plant system depicted in FIG. 2. The aircraft control system 88 includes several systems that work in conjunction with one another to provide additional power modes useful to improve overall aircraft performance. The aircraft control system 88 includes the electric machine controller 86, guidance and navigation system 90, automatic flight control system (AFCS) 92, air data computer (ADC) 94, full authority digital engine control/flight control computer (FADEC/FCC) 96, aircraft actuators 98, and flight displays 100. In the illustrated embodiment the electric machine controller 86 takes the form of a fault detection and mitigation controller (FDMC) having similar capabilities discussed above with respect to the electric machine controller 86. Reference herein in the figures to the FDMC 86 is for ease of convenience and will be appreciated as having the same capabilities discussed elsewhere related to the electric machine controller 86.

The guidance and navigation system 90 is configured to receive pilot guidance commands (e.g., received through switches/knobs manipulated by a pilot or dispatcher) and calculate a flight path to achieve the guidance commands. For example, during flight it may be desired to control the guidance of the aircraft in one or more of several different modes, two of which are listed in block 102: lateral navigation (LNAV) and vertical navigation (VNAV). A cost index (CI) can also be provided in the block 102 useful to calculate a cruise and/or climb speed to achieve the commands entered by a pilot into the guidance & navigation system 90. The modes listed in block 102 are structured to provide lateral and vertical commands to the FADEC/FCC 96 and can take a variety of forms. In one form, the guidance and navigation system 90 provides an offset from a flight path in LNAV mode, or a heading to intercept a waypoint or other navigation fix, also in LNAV mode. In VNAV mode, the guidance and navigation system 90 can also provide an altitude difference from measured altitude to a desired altitude, or provide a desired rate of ascent/decent to achieve a desired altitude. In some forms, the LNAV mode is operated in conjunction with a VNAV mode such that the aircraft is constrained to follow a particular trajectory both in lateral performance and vertical performance. Constraint of a flight profile/trajectory in either or both lateral and vertical modes is sometimes dictated by published procedures or requests from air traffic control.

Whether LNAV or VNAV, or both, the guidance and navigation system 90 takes as inputs pilot guidance selections or commands (e.g., LNAV mode, VNAV mode) as mentioned above as well as the current aircraft state (e.g., altitude, latitude, longitude, airspeed, aircraft body rates and accelerations, etc.), which can be provided by a navigation system such as an integrated Global Navigation Satellite System/Inertial Navigation System (GNSS/INS). Upon receiving pilot commands and current aircraft state, the guidance and navigation system 90 is structured to calculate flight path changes needed to achieve the pilot command. For example, if LNAV is initiated to fly to a waypoint, the guidance and navigation system 90 can determine a heading change required to intercept the waypoint based on current heading. Any variety of other aircraft flight path changes are contemplated based on any number of factors such as whether any of the LNAV and/or VNAV modes are selected and current aircraft state. In general, and as stated above, the guidance and navigation system 90 can calculate a flight path change (e.g., heading change, altitude change) based upon current aircraft state and desired flight path (e.g., a path to a destination/waypoint, etc.). The guidance and navigation system 90 communicates any variety of data to the FADEC/FCC 96 so that trajectory changes can be made to achieve the desired guidance. Data communicated by the guidance and navigation system 90 to the FADEC/FCC 96 include, but are not limited to, the flight path changes calculated by the guidance and navigation system 90 needed to achieve the pilot command, but also, in some instances, the pilot commands and GNSS/INS data as well. The FADEC/FCC 96 is configured to receive the data communicated by the guidance and navigation system 90 and generate flight control surface commands to achieve the commands issued by the guidance and navigation system 90.

Data communicated between the various systems depicted in FIG. 3 can be realized through wired or wireless communications, and, in one particular form, is performed over wired communications using one or more aircraft buses. Any variety of bus protocols can be used, whether civilian or military, such as United States military standard MIL-STD-1553, or civilian standards such as the Aeronautical Radio, Incorporated standards ARINC 429, ARINC 629, to set forth just a few examples.

The automatic flight control system (AFCS) 92 is configured to receive pilot inputs (e.g., stick and rudder inputs, trim commands, button and switch selections, etc.) and determine appropriate control commands, such as, but not limited to, one or more flight control surfaces. In one non-limiting example, the AFCS 92 can receive a pilot stick command to pitch the aircraft, where such pitch command can be directly related to, for example, an elevator command in a stability augmentation system (SAS). Such conversion of stick command to elevator command can be realized through, for example, a 2-dimensional table lookup that relates elevator command to stick command. The AFCS 92 can also include the integrated GNSS/INS system mentioned above, capable of measuring pitch/roll/yaw angles and rates, accelerations along any of the three aircraft axes, and aircraft position, among potential others. Any number of useful sensors such as rate gyros, accelerometers, magnetic compass, as well as global position system (GPS) signals, can be used. It will be understood that other GNSS systems beyond GPS are contemplated herein, including any of GLONASS, Galileo, and BeiDou system, among potential others.

The GNSS/INS can be configured to produce sensor data signals representative of the various sensors and GNSS signals. It will be appreciated that while many of the sensor data signals are measured directly from the various sensors, some sensor data signals are calculated. For example, GNSS system performance can be a calculated value, along with Kalman filter values of various synthesized sensor signals. In short, the sensor data signals represent measured sensors and calculated values useful to assess the current flight state of the aircraft. Data from the integrated GNSS/INS system, whether measured or calculated, can be provided by the AFCS 92 over the aircraft data bus to the FADEC/FCC 96.

To stabilize and control the aircraft, the AFCS 92 can ‘close the loop’ through any suitable control system having any variety of architecture by using pilot input data signals and sensor data signals as input and producing control surface actuator commands as output. For example, the AFCS 92 can ‘close the loop’ with a control augmentation system (CAS) or stability augmentation system (SAS), among potential others, using any of classical control schemes (e.g., proportional-integral-derivative (PID) control), state-space control schemes (e.g., linear quadratic regulator (LQR) control), or robust control schemes (e.g., linear parameter varying (LPV) control), among potential others. Other suitable control systems are also contemplated herein. It will be appreciated, however, that loop closure can alternatively be accomplished at the FADEC/FCC 96, in which case the AFCS 92 may communicate over the aircraft data bus information regarding pilot commands and sensor feedback from the integrated GNSS/INS system.

Although the functions of the guidance and navigation system 90 and the AFCS 92 have been discussed separately, in some embodiments the guidance and navigation system 90 and the AFCS 92 are integrated as a system to communicate over the aircraft data bus to the FADEC/FCC 96. Such an integrated system of the guidance and navigation system 90 and the AFCS 92 can be referred to herein as the flight controller 104. Thus, the flight controller 104 is structured to receive pilot commands and generate a flight control command. The flight controller 104 can include additional features such as the integrated GNSS/INS system which can result in additional information being communicated over the aircraft bus to the FADEC/FCC 96. In some forms, functions of the FADEC/FCC 96 can be considered part of the flight controller 104 (e.g., if aircraft control loop closure is performed in the FADEC/FCC 96).

The ADC 94 is capable of collecting information related to air data of the aircraft and communicating such information to other systems of the aircraft control system 88. Air data can be measured and/or estimated by a variety of sensors and techniques, such as those indicated in block 106 which include static pressure (Ps), total pressure (Pt), total temperature (Tt), and angle of attack (AoA). Aircraft airspeed can be calculated by the ADC 94 using pressure ports typically provided in a pitot probe system which provide the static and total pressure. One or more pitot probes can be used for redundancy purposes. Various calculations can be made to determine the type of airspeed provided, such as but not limited to calculations of indicated air speed (IAS) and calibrated airspeed (CAS). Calculated air data such as Mach number can also be provided by the air data computer 94 using a temperature probe such as one constructed to measure total temperature. As in various measures of airspeed, Mach number calculations can be performed using one or more total temperature probes. The air data computer 94 can also provide for a measurement of angle of attack using a suitable device such as an angle of attack vane. Some estimates or other calculations can also be performed to provide any additional useful information such as true airspeed and equivalent airspeed. In short, the ADC 94 collects information from various sensors and calculates/estimates aircraft air data including indicated air speed, vertical speed, and Mach number. Any number of measures or calculations can be provided by the ADC 94 over the aircraft data bus to the FADEC/FCC 96.

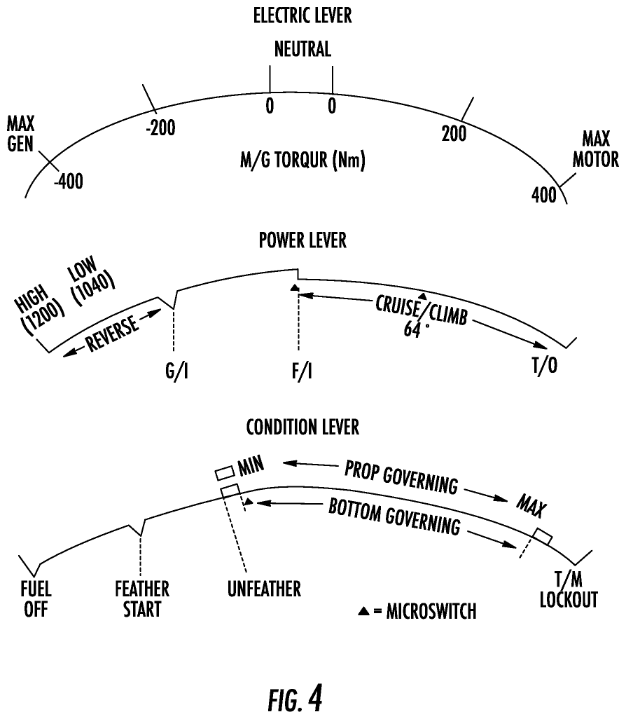

The FADEC/FCC 96 is the primary system useful to control the hybrid engine illustrated in FIG. 2 as well as regulate position of the flight control surfaces via the control surface actuators 98. The FADEC is responsible for receiving a pilot input, such as a throttle command, and regulating engine fuel flow, variable stator vane position, etc., to provide a requested power output from the pilot. FIG. 4 depicts various power settings that are controllable by a pilot for the hybrid powerplant system depicted in FIG. 2. The top portion of the figure depicts a setting controllable by the pilot requesting that the MG 71 operate in a generator mode or a motor mode, including the power setting in each of the modes. The electric lever position shown at the top of FIG. 4 can be provided to the FADEC/FCC 96, or, in some embodiments, can be provided direct to the FDMC 86. Such pilot selection of the top portion of the figure can be overridden in some modes of operation of the system 88 as will be described further below. The middle portion of FIG. 4 depicts a power lever setting capable of being set by the pilot including a ground idle (G/I), flight idle (F/I), cruise/climb power, and take off (T/O) power settings. The bottom portion of FIG. 4 depicts the prop condition lever indicating whether the propeller is in a start position, a feather position, and an unfeathered position. Each of the levers depicted in FIG. 4 (e.g., electric lever, power lever, and condition lever) can be manipulated by the pilot to regulate engine power as needed during flight. The FADEC/FCC can receive signals related to each of the levers depicted and regulate operation of the engine 10.

The FCC of the FADEC/FCC 96 is used to receive relevant information regarding the status of the aircraft in flight, receive pilot inputs, and formulate a command to the aircraft surfaces via the actuators 98. The technique of combining the various inputs, parameters, and feedbacks to produce a command is generally referred to as ‘closing the loop.’ As will be appreciated from the discussion above, receiving guidance commands from the flight controller 104 as well as data from the AFCS 92, the FADEC/FCC 96 is structured to generate commands to the actuators 98. The FADEC/FCC 96 depicted in FIG. 3 serves as the primary system used to generate commands to the actuators 98 for flight control purposes.

The displays 100 are used to provide pertinent information to the pilot regarding various aspects of the aircraft, including the aircraft control system 88. The displays can be configured as LCD displays, or cathode ray tube displays, etc. The displays can also be integrated with one or more buttons, such as buttons along the periphery of the displays. In some forms, the displays can be touch screen displays permitting the selection of information on the screen in addition or alternatively to the buttons around the periphery. The display labelled as PFD is a primary flight display and can be used to display aircraft attitude and altitude information. The block labelled as MFD is a multifunctional display which can be used to display navigation and/or aircraft system information. The block labelled as EICAS is an engine instruments display.

As shown in FIG. 3, the flight controller 104 and ADC 94 also are configured to communicate with the FDMC 86 over an aircraft data bus, just as the flight controller 104 and ADC 94 were configured to communicate with the FADEC/FCC 96 over the aircraft data bus discussed above. The FDMC 86 is configured to control the MG 71 in at least one mode of operation of the aircraft control system 88, such as but not limited to a mode which requires automatic torque control of the hybrid engine. During some phases of flight, such as in a VNAV mode where precise control of the rate of ascent or rate of descent, along with maintaining a set speed, the ability to accurately produce a set amount of thrust from the hybrid powerplant depicted in FIG. 2 is important. For example, the FDMC 86 can be structured to receive data from the flight controller 104, determine that the aircraft control system is in VNAV mode, and control the MG 71 to either augment or subtract power provided from the turboprop engine 10. The FDMC 86 can command the MG 71 to either add power to (motor mode of the motor-generator) or take power from (generator mode of the motor-generator) the turboprop engine 10. Such power addition or subtraction can be faster than the response time of a turboprop engine 10 owing to engine core momentum effects and fuel delivery response speed. The FDMC 86 can control the MG 71 during the entire time in the VNAV mode, or can be configured to control the MG 71 during an initial transition into the VNAV mode at which time the engine 10 may achieve its desired power condition. Thus, the FDMC 86 can act as a transition controller to quickly achieve needed power output from the hybrid engine system depicted in FIG. 2 (e.g., in response to the flight path change noted above), and/or can act as a trim controller to remedy any steady state offset in power delivered from the turboprop engine 10 (e.g., in response to the flight path change noted above).

Prior to initiation and during operation of the FDMC 86 in the auto-torque mode or VNAV mode of operation described above, the FDMC can perform a logic test to determine whether the MG 71 can be operated. To the right of FIG. 3 is depicted example logic that the FDMC 86 can execute which evaluates data related to the electrical power plant system (e.g., including MG 71, energy storage 73, DC bus 74, and MG controller 76) and related to torque provided to the propeller 14. Decision block 108 tests whether certain conditions of systems meet a threshold requirement for operation of the MG 71. Specifically, decision block 108 tests whether the state of charge (SoC) of the energy storage 73 meets a threshold requirement, whether a torque of the motor 71 (Qm) meets a threshold requirement (e.g., 40% max torque of motor; 50% max torque of motor; 60% max torque of motor; 75% max torque of motor), and whether a torque of the propeller (Qp) meets a threshold requirement (e.g., 40% max propeller torque; 50% max propeller torque; 60% max propeller torque; 75% max propeller torque). In the illustrated embodiment, the threshold torque tests are whether Qm is below a maximum value and whether Qp is below a maximum value, where the maximum value can be a system imposed maximum value or a maximum threshold value (such as any of the values specified immediately above). Any of the values for SoC, Qm, and Qp can be invariant during the course of a flight, or can be a function of flight condition and/or flight status (e.g., an emergency condition). As will be appreciated, the decision logic depicted in decision block 108 is performed for each of the separate engines 10. If any of the threshold tests are not met, then the MG 71 is requested to stop and an advisory is sent to the EICAS of displays 100.

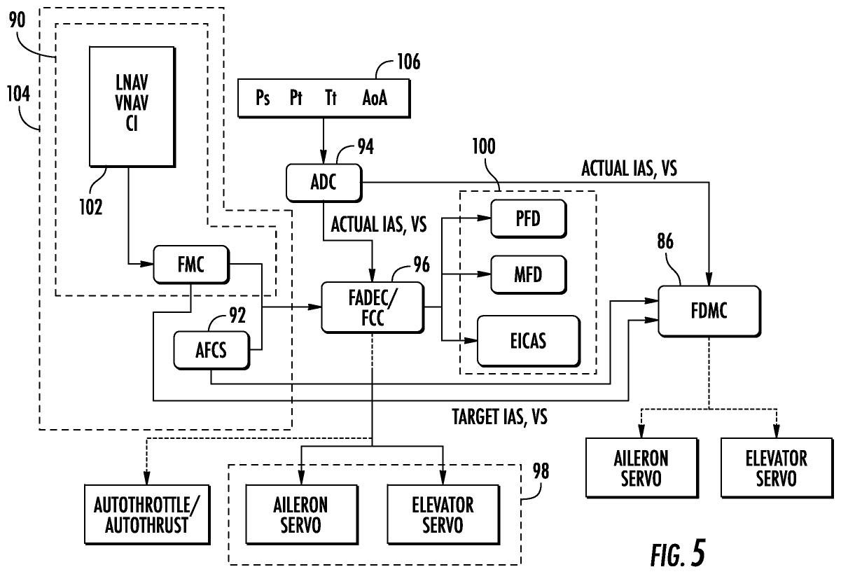

An alternative embodiment to FIG. 3 is depicted in FIG. 5 in which the FDMC 86 can be configured to provide a backup command to the FADEC/FCC 96. The FDMC 86 can be configured to receive the same data as that received by the FADEC/FCC 96 over the aircraft data bus. In the embodiment depicted in FIG. 5, the same control logic used by the FADEC/FCC 96 (i.e., the ‘loop closure’ referred to above using pilot commands, guidance commands, and sensor information) can be replicated in the FDMC 86 to provide a backup flight control actuator command to the actuators 98. Such backup redundancy can be helpful in the event of a failure or degradation in the FADEC/FCC 96, or a power out/degraded operating condition of the engine 10. In addition, the FADEC/FCC 96 can be used to perform an autothrottle/autothrust of the engine in response to selection of flight mode by the pilot and/or selection of a navigation mode such as VNAV.

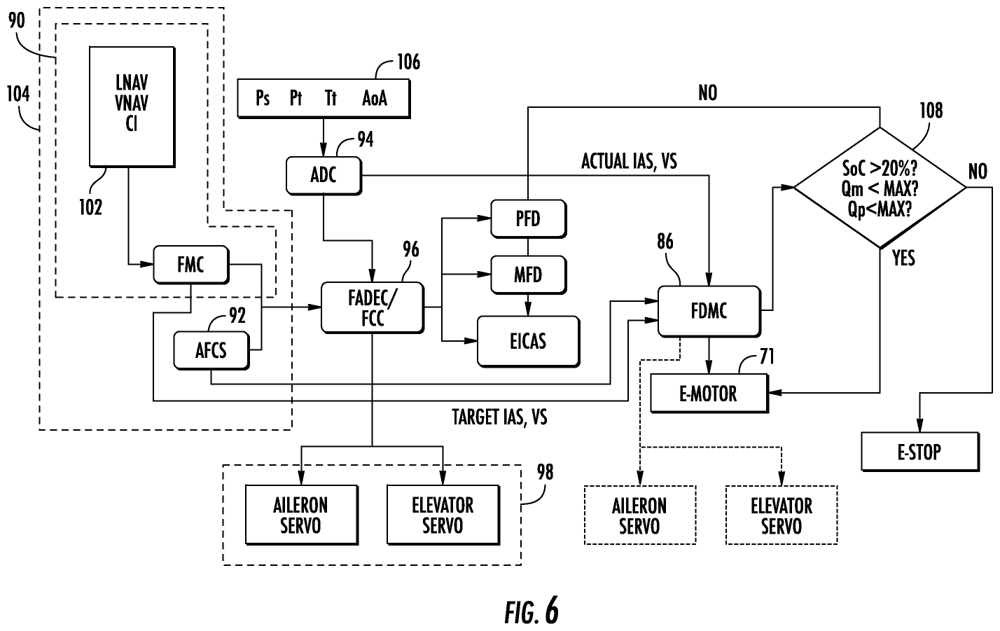

FIG. 6 depicts a combination of features described above with respect to FIGS. 3 and 5. In the embodiment depicted in FIG. 6, the FDMC 86 provides the auto-torque capability discussed above with respect to FIG. 3, and also provides the backup commands to the actuators 98 as described in FIG. 5. The decision logic described above in decision block 108 with respect to the FDMC 86 in FIG. 3 are also used in FIG. 6.

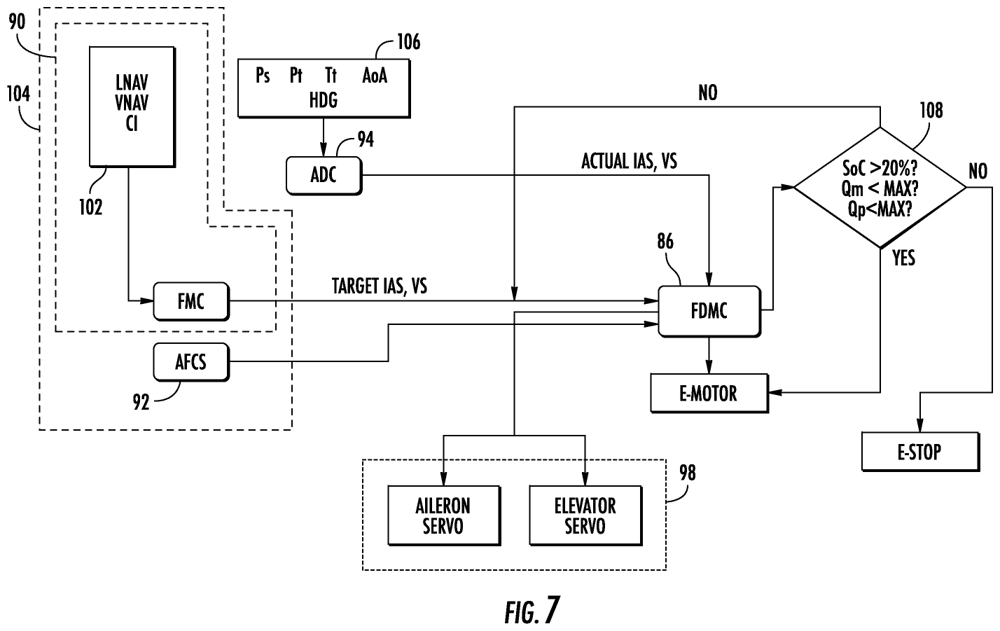

Some aircraft may not have FADEC/FCC systems such as system 96 depicted above. Incorporation of a hybrid aircraft powerplant system as described herein may provide analogous capabilities as those provided in the embodiments that use a FADEC/FCC. In the embodiment depicted in FIG. 7, the FDMC 86 can provide primary control of the actuators 98 through loop closure in the FDMC 86 after receipt of guidance commands from the guidance and navigation system 90, pilot commands from the AFCS 92, and air data from the ADC 94. The FDMC 86 of the embodiment in FIG. 7 can also provide the auto-torque capabilities described above in FIG. 3.

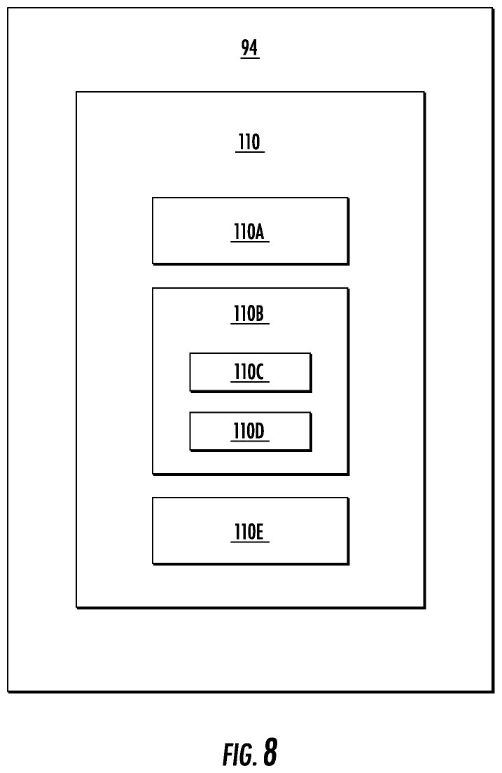

Turning now to FIG. 8, any of the systems, or components of the systems, associated with FDMC 86, ADC 94, AFCS 92, FADEC/FCC 96, integrated GNSS/INS system, guidance and navigation system 90, or displays 100 can be implemented using a computing device 110, one embodiment of which is illustrated in FIG. 8. The embodiment depicted in FIG. 8 uses the ADC 94 as an exemplary device having the computing device 110, but it will be understood that any of the other systems, or components of the systems are also contemplated. The computing device(s) 110 can include one or more processor(s) 110A and one or more memory device(s) 110B. The one or more processor(s) 110A can include any suitable processing device, such as a microprocessor, microcontroller, integrated circuit, logic device, and/or other suitable processing device. The one or more memory device(s) 110B can include one or more computer-readable media, including, but not limited to, non-transitory computer-readable media, RAM, ROM, hard drives, flash drives, and/or other memory devices.

The one or more memory device(s) 110B can store information accessible by the one or more processor(s) 110A, including computer-readable instructions 110C that can be executed by the one or more processor(s) 110A. The instructions 110C can be any set of instructions that when executed by the one or more processor(s) 110A, cause the one or more processor(s) 110A to perform operations. In some embodiments, the instructions 110C can be executed by the one or more processor(s) 110A to cause the one or more processor(s) 110A to perform operations, such as any of the operations and functions for which the controller and/or the computing device(s) 110 are configured, the operations for any of the aforementioned systems such as variable stator vanes 60 and/or 70, electric machine 71, fuel flow to the combustion section 26, etc., as described herein, and/or any other operations or functions of the one or more computing device(s) 110. The instructions 110C can be software written in any suitable programming language or can be implemented in hardware. Additionally, and/or alternatively, the instructions 110C can be executed in logically and/or virtually separate threads on the one or more processor(s) 110A. The one or more memory device(s) 110B can further store data 110D that can be accessed by the one or more processor(s) 110A. For example, the data 110D can include data indicative of power flows, data indicative of engine/aircraft operating conditions, and/or any other data and/or information described herein.

The computing device(s) 110 can also include a network interface 110E used to communicate, for example, with the other components of the systems described herein (e.g., via a communication network). The network interface 110E can include any suitable components for interfacing with one or more network(s), including for example, transmitters, receivers, ports, controllers, antennas, and/or other suitable components. One or more devices can be configured to receive one or more commands from the computing device(s) 110 or provide one or more commands to the computing device(s) 110.

The network interface 110E can include any suitable components for interfacing with one or more network(s), including for example, transmitters, receivers, ports, controllers, antennas, and/or other suitable components.

The technology discussed herein makes reference to computer-based systems and actions taken by and information sent to and from computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

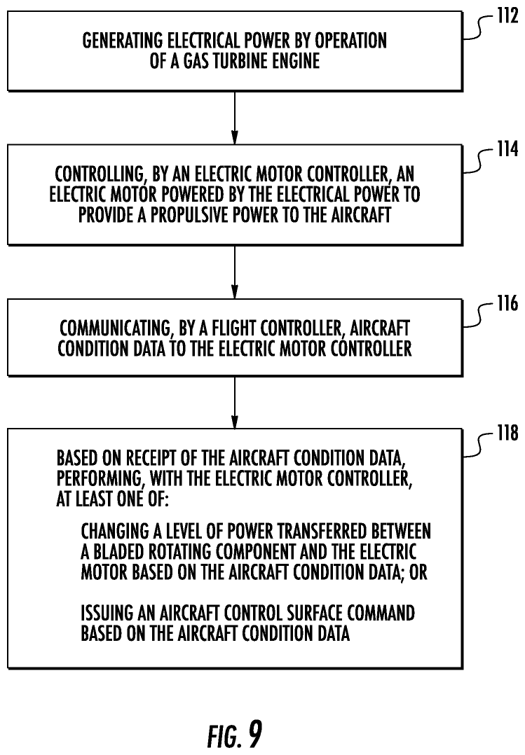

FIG. 9 discloses a method of operating a hybrid electric gas turbine engine configured to provide propulsive power to an aircraft (such as the hybrid aircraft power plant system depicted in FIG. 2) which includes at step 112 of generating electrical power by operation of a gas turbine engine. Step 114 includes controlling, by an electric motor controller, an electric motor powered by the electrical power to provide a propulsive power to the aircraft. The electric motor controller, as mentioned above, can take the form of the FDMC 86. Step 116 includes communicating, by a flight controller, aircraft condition data to the electric motor controller. The aircraft condition data can include that data made available on the aircraft data bus from the guidance and navigation system 90 and/or the AFCS 92. In some forms, the aircraft condition data can also include data from the ADC 94 also made available on the aircraft data bus. Step 118 recites elements in the alternative based on receipt of the aircraft condition data. The alternatives listed in step 118 include performing, with the electric motor controller, at least one of: (1) changing a level of power transferred between the bladed rotating component and the electric motor based on the aircraft condition data; and (2) issuing an aircraft control surface command based on the aircraft condition data. As will be appreciated given the discussion above, the electric machine controller 86 can be used to regulate power between the electric machine and bladed rotating component in response to a commanded flight path change based on a difference between a current aircraft state and desired flight path. The desired flight path can be the result of selection of a flight mode (e.g., VNAV and/or LNAV mode). Thus, power delivered to the bladed rotating component can be determined through a combination of the gas turbine engine and the electric machine in response to a navigation performance of the aircraft. Thus, the electric motor controller can change power transferred between the bladed rotating component and the electric motor based on the current aircraft state as well as based on other information, such as, but not limited to, a desired flight path.

The arrangement of the aircraft control system 88 provides various technical effects, including the ability to precisely regulate aircraft trajectory in response to a navigation mode request command (e.g., LNAV and/or VNAV). For example, the FDMC 86 can act as a transition controller to quickly achieve needed power output from the hybrid engine system and/or can act as a trim controller to remedy any steady state offset in power delivered from the turboprop engine 10 when attempting to fly in a navigation mode. Additionally and/or alternatively, the FDMC 86, in various embodiments described herein, is also capable of generating aircraft surface commands in addition to regulating power transfer of the MG 71 with the propeller 14. Such a technical effect provides redundancy of control to the control surface actuators 98 should a primary system used to regulate the control surface actuators 98 unexpectedly fails (e.g., failure of the FADEC/FCC 98). Further, such technical effect can, in some forms, permit the elimination of redundant hardware (e.g., the elimination of the FADEC/FCC 96 in FIG. 7) and/or provide the ability to upgrade an aircraft that otherwise already lacks such hardware (e.g., already lacks a FADEC/FCC 96)0.

Further aspects are provided by the subject matter of the following clauses:

An aircraft system comprising: a bladed rotating component of an aircraft configured to provide propulsive power to the aircraft; a hybrid electric gas turbine engine powerplant having an electric machine and a gas turbine engine, the gas turbine engine structured to generate an energy to rotate the bladed rotating component, the electric machine in mechanical power communication with the bladed rotating component; an electric machine controller configured to monitor and control operation of the electric machine; and a flight controller configured to receive a guidance command and to generate a flight control command for the aircraft, the flight controller configured to communicate aircraft condition data to the electric machine controller, the aircraft condition data based on the guidance command and flight control command; wherein the electric machine controller is configured to receive the aircraft condition data and generate at least one of (1) an electric machine command to modulate power transferred between the bladed rotating component and the electric machine based on the aircraft condition data; and (2) an aircraft control surface command based on the aircraft condition data.

The aircraft system of one or more of these clauses, which further includes the aircraft, and wherein the energy generated by the gas turbine engine is mechanical kinetic energy which is converted to electric energy via the electric machine for use in powering the bladed rotating component.

The aircraft system of one or more of these clauses, wherein the flight controller includes a flight management computer (FMC) and an automatic flight control system (AFCS), wherein the aircraft condition data includes a first data from the flight management computer (FMC) and a second data from the automatic flight control system, the first data and second data separately conveyed to the electric machine from each of the FMC and AFCS, respectively; and which further includes an engine controller configured to control operation of the gas turbine engine.

The aircraft system of one or more of these clauses, which further includes an air data computer (ADC) structured to communicate flight condition data to the electric machine controller; wherein the aircraft control surface command is transmitted to an aircraft control surface actuator to generate movement in an aircraft control surface, the aircraft control surface used to provide flight stability and control of the aircraft.

The aircraft system of one or more of these clauses, wherein the aircraft condition data includes a flight control request data and a target flight condition data, the flight control request data representing an initial control request, the target flight condition data representing a target flight condition of the aircraft including a target speed of the aircraft.

The aircraft system of one or more of these clauses, which further includes an engine controller structured to regulate operation of the gas turbine engine, wherein the engine controller is configured to provide a first level of power provided to the bladed rotating component by virtue of power output of the gas turbine engine, wherein the electric machine command is sized to provide a second level of power provided to the bladed rotating component by virtue of power output of the electric machine, wherein the first level of power is larger than the second level of power.

The aircraft system of one or more of these clauses, wherein the electric machine controller is configured to receive the aircraft condition data and generate both (1) the electric machine command to modulate power transferred between the bladed rotating component and the electric machine based on the aircraft condition data; and (2) the aircraft control surface command based on the aircraft condition data.

The aircraft system of one or more of these clauses, wherein the electric machine controller is configured to generate the aircraft control surface command based on the aircraft condition data as a backup to the flight controller.

The aircraft system of one or more of these clauses, which further includes an aircraft having the aircraft system.

The aircraft system of one or more of these clauses, wherein the gas turbine engine and the electric machine are in a parallel hybrid configuration in that the gas turbine engine and the electric machine provide summative mechanical power to rotate the bladed rotating component.

The aircraft system of one or more of these clauses, wherein the gas turbine engine is configured as a turboshaft engine, and wherein mechanical power used to propel the aircraft is generated solely from the electric machine.

The aircraft system of one or more of these clauses, wherein the flight controller includes an integrated GNSS/INS system.

The aircraft system of one or more of these clauses, wherein the aircraft system lacks a FADEC.

The aircraft system of one or more of these clauses, wherein the aircraft system lacks an integrated FADEC/FCC.

The aircraft system of one or more of these clauses, wherein the aircraft system includes a FADEC/FCC.

The aircraft system of one or more of these clauses, wherein the guidance command includes at least one of a VNAV and an LNAV navigation mode.

The aircraft system of one or more of these clauses, wherein the flight controller is structured to calculate a flight path change based upon current aircraft state and desired flight path.

The aircraft system of one or more of these clauses, wherein the hybrid electric gas turbine engine powerplant is commanded by the electric machine controller in response to a desired flight path.

A hybrid powerplant system for an aircraft comprising: a hybrid electric gas turbine engine powerplant having an electric motor and a gas turbine engine, the gas turbine engine structured to generate an energy to operate the electric motor and thereby provide mechanical power to propel the aircraft; an electric motor controller configured to modulate the mechanical power provided by the electric motor; and a flight controller configured to provide a guidance, navigation, and control (GNC) control action for the aircraft, the flight controller configured to communicate aircraft condition data to the electric motor controller; wherein the electric motor controller is configured to receive the aircraft condition data and perform at least one of: (1) change a level of mechanical power delivered by the electric motor to propel the aircraft based on the aircraft condition data; and (2) generate an aircraft control surface command based on the aircraft condition data during a failure of the flight controller.

The hybrid powerplant system for an aircraft of one or more of these clauses, which further includes the aircraft having a control surface actuator structured to generate motion in a control surface of the aircraft.

The hybrid powerplant system for an aircraft of one or more of these clauses, which further includes an air data computer (ADC) configured to generate and send an air data signal to the electric motor controller.

The hybrid powerplant system for an aircraft of one or more of these clauses, wherein the flight controller includes a flight management computer (FMC) and an automatic flight control system (AFCS), the FMC configured to receive a guidance command, the AFCS configured to generate the aircraft control surface command for the aircraft, the FMC and the AFCS configured to convey the aircraft condition data to the electric motor controller, wherein the aircraft condition data includes a data from the flight management computer and a data from the automatic flight control system.

The hybrid powerplant system for an aircraft of one or more of these clauses, wherein the gas turbine engine and the electric motor are in a parallel hybrid configuration in that the gas turbine engine and the electric motor provide summative mechanical power to rotate a bladed rotating component.

The hybrid powerplant system for an aircraft of one or more of these clauses, wherein the gas turbine engine is configured as a turboshaft engine, and wherein the mechanical power is generated solely from the electric motor.

The hybrid powerplant system for an aircraft of one or more of these clauses, wherein the electric motor is in mechanical power communication with a bladed rotating component; and wherein the electric motor controller is further configured to generate an electric motor command to modulate power transferred with the bladed rotating component based on the aircraft condition data, target flight condition data.

The hybrid powerplant system for an aircraft of one or more of these clauses, which further includes an electric generator and an energy storage device, the electric generator structured to withdraw power from the gas turbine engine, the electric generator in electrical communication with the energy storage device, the energy storage device in electric communication with the electric motor.

The hybrid powerplant system of one or more of these clauses, wherein the flight controller includes an integrated GNSS/INS system.

The hybrid powerplant system of one or more of these clauses, wherein the aircraft system lacks a FADEC.

The hybrid powerplant system of one or more of these clauses, wherein the aircraft system lacks an integrated FADEC/FCC.

The hybrid powerplant system of one or more of these clauses, wherein the aircraft system includes a FADEC/FCC.

The hybrid powerplant system of one or more of these clauses, wherein the guidance command includes at least one of a VNAV and an LNAV navigation mode.

The hybrid powerplant system of one or more of these clauses, wherein the flight controller is structured to calculate a flight path change based upon current aircraft state and desired flight path.

The hybrid powerplant system of one or more of these clauses, wherein the hybrid electric gas turbine engine powerplant is commanded by the electric machine controller in response to a desired flight path.

A method of operating a hybrid electric gas turbine engine configured to provide propulsive power to an aircraft having a bladed rotating component, the method comprising: generating electrical power by operation of a gas turbine engine; controlling, by an electric motor controller, an electric motor powered by the electrical power to provide a propulsive power to the aircraft; communicating, by a flight controller, aircraft condition data to the electric motor controller; and based on receipt of the aircraft condition data, performing, with the electric motor controller, at least one of: changing a level of power transferred between the bladed rotating component and the electric motor based on the aircraft condition data; and issuing an aircraft control surface command based on the aircraft condition data.

The method of operating a hybrid electric gas turbine engine configured to provide propulsive power to an aircraft having a bladed rotating component of one or more of these clauses, which further includes rotating a bladed rotating component using the electric motor, the bladed rotating component providing the propulsive power to the aircraft.

The method of operating a hybrid electric gas turbine engine configured to provide propulsive power to an aircraft having a bladed rotating component of one or more of these clauses, wherein the gas turbine engine is structured to provide mechanical power to the bladed rotating component.

The method of operating a hybrid electric gas turbine engine configured to provide propulsive power to an aircraft having a bladed rotating component of one or more of these clauses, wherein the aircraft condition data includes a flight control request data and a target flight condition data, the flight control request data representing an initial control request, the target flight condition data representing a target flight condition of the aircraft including a target speed of the aircraft.

The method of operating a hybrid electric gas turbine engine configured to provide propulsive power to an aircraft having a bladed rotating component of one or more of these clauses, wherein the flight controller includes an integrated GNSS/INS system.

The method of operating a hybrid electric gas turbine engine configured to provide propulsive power to an aircraft having a bladed rotating component of one or more of these clauses, wherein the aircraft system lacks a FADEC.

The method of operating a hybrid electric gas turbine engine configured to provide propulsive power to an aircraft having a bladed rotating component of one or more of these clauses, wherein the aircraft system lacks an integrated FADEC/FCC.

The method of operating a hybrid electric gas turbine engine configured to provide propulsive power to an aircraft having a bladed rotating component of one or more of these clauses, wherein the aircraft system includes a FADEC/FCC.

The method of operating a hybrid electric gas turbine engine configured to provide propulsive power to an aircraft having a bladed rotating component of one or more of these clauses, which further includes communicating a guidance command to the electric motor controller, wherein the guidance command includes at least one of a VNAV and an LNAV navigation mode.

The method of operating a hybrid electric gas turbine engine configured to provide propulsive power to an aircraft having a bladed rotating component of one or more of these clauses, which further includes calculating, with the flight controller, a flight path change based upon current aircraft state and desired flight path.

The method of operating a hybrid electric gas turbine engine configured to provide propulsive power to an aircraft having a bladed rotating component of one or more of these clauses, which further include commanded, by the electric machine controller, the hybrid electric gas turbine engine powerplant in response to a desired flight path.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

We claim:

1. An aircraft system comprising:
a bladed rotating component of an aircraft configured to provide propulsive power to the aircraft;
a hybrid electric gas turbine engine powerplant having an electric machine and a gas turbine engine, the gas turbine engine structured to generate an energy to rotate the bladed rotating component, the electric machine in mechanical power communication with the bladed rotating component;
an electric machine controller configured to monitor and control operation of the electric machine; and
a flight controller configured to receive a guidance command and to generate a flight control command for the aircraft, the flight controller configured to communicate aircraft condition data to the electric machine controller, the aircraft condition data based on the guidance command and flight control command;
wherein the electric machine controller is configured to receive the aircraft condition data and generate at least one of (1) an electric machine command to modulate power transferred between the bladed rotating component and the electric machine based on the aircraft condition data; and (2) an aircraft control surface command based on the aircraft condition data.

2. The aircraft system of claim 1, which further includes the aircraft, and wherein the energy generated by the gas turbine engine is mechanical kinetic energy which is converted to electric energy via the electric machine for use in powering the bladed rotating component, wherein the guidance command is at least one of a vertical navigation (VNAV) mode and a lateral navigation (LNAV) mode, and wherein power delivered to the bladed rotating component from the hybrid electric gas turbine engine powerplant is based on the guidance command.

3. The aircraft system of claim 1, wherein the flight controller includes a flight management computer (FMC) and an automatic flight control system (AFCS), wherein the aircraft condition data includes a first data from the flight management computer (FMC) and a second data from the automatic flight control system, the first data and second data separately conveyed to the electric machine from each of the FMC and AFCS, respectively; and which further includes an engine controller configured to control operation of the gas turbine engine.

4. The aircraft system of claim 1, which further includes an air data computer (ADC) structured to communicate flight condition data to the electric machine controller; wherein the aircraft control surface command is transmitted to an aircraft control surface actuator to generate movement in an aircraft control surface, the aircraft control surface used to provide flight stability and control of the aircraft.

5. The aircraft system of claim 1, wherein the aircraft condition data includes a flight control request data and a target flight condition data, the flight control request data representing an initial control request, the target flight condition data representing a target flight condition of the aircraft including a target speed of the aircraft.

6. The aircraft system of claim 1, which further includes an engine controller structured to regulate operation of the gas turbine engine, wherein the engine controller is configured to provide a first level of power provided to the bladed rotating component from the gas turbine engine, wherein the electric machine command is sized to provide a second level of power provided to the bladed rotating component by virtue of power output of the electric machine, wherein the first level of power is larger than the second level of power.

7. The aircraft system of claim 1, wherein the electric machine controller is configured to receive the aircraft condition data and generate both (1) the electric machine command to modulate power transferred between the bladed rotating component and the electric machine based on the aircraft condition data; and (2) the aircraft control surface command based on the aircraft condition data.

8. The aircraft system of claim 1, wherein the electric machine controller is configured to generate the aircraft control surface command based on the aircraft condition data as a backup to the flight controller.

9. A hybrid powerplant system for an aircraft comprising:
a hybrid electric gas turbine engine powerplant having an electric motor and a gas turbine engine, the gas turbine engine structured to generate an energy to operate the electric motor and provide mechanical power to propel the aircraft;
an electric motor controller configured to modulate the mechanical power provided by the electric motor; and
a flight controller configured to provide a guidance, navigation, and control (GNC) control action for the aircraft, the flight controller configured to communicate aircraft condition data to the electric motor controller;
wherein the electric motor controller is configured to receive the aircraft condition data and perform at least one of: (1) change a level of mechanical power delivered by the electric motor to propel the aircraft based on the aircraft condition data; and (2) generate an aircraft control surface command based on the aircraft condition data during a failure of the flight controller.

10. The hybrid powerplant system of claim 9, which further includes the aircraft having a control surface actuator structured to generate motion in a control surface of the aircraft, wherein the flight controller is configured to receive a guidance command, wherein the guidance command is at least one of a VNAV navigation mode and an LNAV navigation mode, and wherein the mechanical power used to propel the aircraft from the hybrid electric gas turbine engine powerplant is based on the guidance command.

11. The hybrid powerplant system of claim 9, which further includes an air data computer (ADC) configured to generate and send an air data signal to the electric motor controller.

12. The hybrid powerplant system of claim 9, wherein the flight controller includes a flight management computer (FMC) and an automatic flight control system (AFCS), the FMC configured to receive a guidance command, the AFCS configured to generate the aircraft control surface command for the aircraft, the FMC and the AFCS configured to convey the aircraft condition data to the electric motor controller, wherein the aircraft condition data includes a data from the flight management computer and a data from the automatic flight control system.

13. The hybrid powerplant system of claim 9, wherein the gas turbine engine and the electric motor are in a parallel hybrid configuration in that the gas turbine engine and the electric motor provide summative mechanical power to rotate a bladed rotating component.

14. The hybrid powerplant system of claim 9, wherein the gas turbine engine is configured as a turboshaft engine, and wherein the mechanical power is generated solely from the electric motor.

15. The hybrid powerplant system of claim 9, wherein the electric motor is in mechanical power communication with a bladed rotating component; and wherein the electric motor controller is further configured to generate an electric motor command to modulate power transferred with the bladed rotating component based on the aircraft condition data, target flight condition data.

16. The hybrid powerplant system of claim 9, which further includes an electric generator and an energy storage device, the electric generator structured to withdraw power from the gas turbine engine, the electric generator in electrical communication with the energy storage device, the energy storage device in electric communication with the electric motor.

17. A method of operating a hybrid electric gas turbine engine configured to provide propulsive power to an aircraft having a bladed rotating component, the method comprising:
generating electrical power by operation of a gas turbine engine;
controlling, by an electric motor controller, an electric motor powered by the electrical power to provide a propulsive power to the aircraft;
communicating, by a flight controller, aircraft condition data to the electric motor controller; and
based on receipt of the aircraft condition data, performing, with the electric motor controller, at least one of:
changing a level of power transferred between the bladed rotating component and the electric motor based on the aircraft condition data; and
issuing an aircraft control surface command based on the aircraft condition data.

18. The method of claim 17, which further includes rotating a bladed rotating component using the electric motor, the bladed rotating component providing the propulsive power to the aircraft.

19. The method of claim 18, wherein the gas turbine engine is structured to provide mechanical power to the bladed rotating component.

20. The method of claim 17, wherein the aircraft condition data includes a flight control request data and a target flight condition data, the flight control request data representing an initial control request, the target flight condition data representing a target flight condition of the aircraft including a target speed of the aircraft.
